(19) United States
(12) Patent Application Publication
(10) Pub. No.: US 2026/0160893 A1
(43) Pub. Date: Jun. 11, 2026

(54) METHOD FOR DETECTING OBSTACLES WITH A LIDAR OBSTACLE SENSOR SYSTEM FOR A ROTARY-WING AIRCRAFT

(71) Applicant: AIRBUS HELICOPTERS, Marignane Cedex (FR)

(72) Inventors: Amine BRAHMI, Marseille (FR); Rémi GIRARD, Istres (FR); Romain MIRET, Aix En Provence (FR); Esteban MATEOS, Aix En Provence (FR)

(73) Assignee: AIRBUS HELICOPTERS, Marignane Cedex (FR)

(21) Appl. No.: 19/358,363

(22) Filed: Oct. 14, 2025

(30) Foreign Application Priority Data
Dec. 6, 2024 (FR) FR2413539

(51) Int. Cl. G01S 17/933; G01S 7/51; G01S 17/04; G01S 17/10

(52) U.S. Cl. CPC G01S 17/933; G01S 7/51; G01S 17/04; G01S 17/10

(57) ABSTRACT

A method of detecting obstacles with an aircraft having at least one rotary wing. Said method comprises: i) acquiring a point cloud detected using at least one LIDAR obstacle sensing device; ii) positioning each detected point in an orthonormal reference frame attached to the aircraft having a first axis coincident with an axis of rotation of the rotary wing; iii) dividing the surrounding space into volumetric units, the detected point or points present in the same volumetric unit being all replaced by a representative point; iv) segmenting the ground; v) determining the presence or absence of at least one obstacle based on the distinct representative points of the ground; and displaying, on a display, a symbology illustrating said obstacle with respect to the aircraft.

### CROSS REFERENCE TO RELATED APPLICATION

This application claims priority to French patent application No. FR 24 13539 filed on December 6, 2024, the disclosure of which is incorporated in its entirety by reference herein.

### TECHNICAL FIELD

The present disclosure relates to a method of detecting obstacles using a LIDAR obstacle sensing device system for a rotary-wing aircraft.

### BACKGROUND

An aircraft may comprise one or more systems to avoid an in-flight collision with an obstacle, such as a building, a pylon, a cable, a crane, or the like. The term "obstacle" used hereinafter refers to any element able to collide with an aircraft.

Various systems are known to avoid a collision during a flight performed in the vicinity of obstacles, for example during rescue missions in mountains or in an environment congested by pylons, cranes or the like, or during maneuvers close to the ground.

Such a system may comprise an active obstacle sensor configured to detect, in flight, one or more obstacles, and a display revealing the detected obstacles. The obstacle sensor may comprise one or more obstacle sensing devices of the type known by the acronym LIDAR (for LIght Detection And Ranging). A LIDAR system is provided with an emitter that sends pulses of light, typically laser light, into a small aperture detection area. When a pulse encounters an obstacle, it is reflected and captured by a receiver. The system is able to detect and calculate the distance to the obstacle by measuring the pulse return time.

If all the obstacles present in the detection field are detected and signaled, then the display presenting these detected points may then be saturated.

However, the obstacle avoidance warning system for helicopters should not further increase the already heavy workload of the pilots. In particular, it is desirable that it does not trigger continuous alerts when the aircraft is flying over the ground, but only focuses on genuine obstacles. If this is not the case, the pilot may disable the system out of frustration. Furthermore, the perception system must be able to quickly analyze and understand the environment in real time. This ensures that each step in the processing chain of the sensing devices is executed within a pre-established time period, allowing the pilots to make informed decisions in a secure framework.

To improve an obstacle detection system, this system may implement a real-time ground segmentation algorithm. More specifically, the pilot looking at the outside world actually has a mental representation of the ground, and the display of symbols illustrating other obstacles may be sufficient to assist him. This technique has the disadvantage of requiring large computational resources and therefore potentially heavy, expensive and/or bulky systems.

In this context, document CN 116524219 A is far removed from the field of the disclosure and relates to an automotive system. This document describes a method comprising a pre-processing of the point cloud obtained using a sensor, a filtering of the point cloud by deletion of outliers, and then sub-sampling. This method comprises a separation between firstly a point cloud corresponding to the ground and secondly a point cloud corresponding to one or more obstacles, by means of a linear adjustment algorithm taking into consideration the rounded shape of a roadway.

Documents EP 4 390 439 A1, Wang Xianzhe et al: "Research on detection method of airborne obstacle avoidance lidar", 20231218, vol. 12963, December 18, 2023 (2023-12-18), pages 1296318-1296318, XP060195426, CN 116 524 219 A, and CN 115 909 277 A are also known.

### SUMMARY

An object of the present disclosure is therefore to propose an innovative method and system for detecting obstacles.

The disclosure thus relates to a method for detecting obstacles, implemented by an aircraft having at least one rotary wing. This obstacle detection method comprises: acquiring a detected point cloud using at least one LIDAR obstacle sensor installed on-board the aircraft; positioning each detected point in a predetermined orthonormal reference frame attached to the aircraft, this reference frame having a first axis coincident with an axis of rotation of the rotary wing; dividing the surrounding space into volumetric units having a predetermined geometry, the detected point or points present in the same volumetric unit being all replaced by a representative point; segmenting the ground by processing in order to detect each ground point belonging to the ground among the representative points; said processing comprising, for each representative point, detecting whether a normal passing through this representative point does or does not form an angle with an axis parallel to the axis of rotation greater than a predetermined angular threshold, said normal being a normal to a surface, this surface comprising this representative point and neighboring points; and determining the presence or absence of at least one obstacle by clustering the representative points distinct from the ground points and, in the presence of at least one obstacle, displaying, on a display, a symbology illustrating said obstacle with respect to the aircraft.

Thus, one or more LIDAR obstacle sensing devices make it possible to acquire a point cloud referred to as "detected points" for convenience.

Then, this detected point cloud is transformed using an approach known by a person skilled in the art as "voxelization". Each volumetric unit is usually referred to as a "voxel". All the detected points present in a volumetric unit are replaced by a single point referred to as a "representative point" for convenience. The size of each volumetric unit influences the number of points to be processed, and consequently the time and resources required to detect obstacles. Large volumetric units will produce a smaller cloud of representative points, but with a risk of loss of fine details, such as those of electrical cables, and vice versa. For example, each volumetric unit has the shape of a cube with sides between 25 centimeters and one meter, or even between 50 centimeters and one meter and, for example, 55 centimeters per side, in order to have good precision while limiting the resources required to implement the method.

The method then comprises a step of segmenting the ground to facilitate the calculations. Due to the specific nature of a rotary-wing aircraft and, for example, a helicopter that has low pitch and roll angles in flight, in particular during flight phases wherein the aircraft flies in the vicinity of obstacles, all the representative points associated with a normal substantially parallel to the axis of rotation of the rotary wing are likely to belong to the ground.

The detection of one or more obstacles is then carried out in the usual way on the basis of all the representative points that are not considered to belong to the ground. For example, in order to detect and identify obstacles, the method may implement a clustering algorithm, such as the algorithm known by the acronym “HDBSCAN” for "Hierarchical Density-Based Spatial Clustering of Applications with Noise” or a Euclidean distance clustering algorithm.

The detected obstacle or obstacles are then represented in a two-dimensional or three-dimensional representation, for example.

Thus, the method of the disclosure enables the ground to be segmented quickly and using reasonable computer means, that can be achieved with a potentially lightweight, inexpensive and/or space-saving system.

The method for detecting obstacles may further comprise one or more of the following features, taken individually or in combination.

According to one possibility, the point representative of a volumetric unit may be the equally-weighted barycenter of the detected points of this volumetric unit, or the barycenter of the detected points of this volumetric unit weighted by a light intensity of these detected points, said light intensity being provided by said LIDAR obstacle sensing device.

According to one possibility compatible with the preceding possibilities, the predetermined angular threshold may be equal to 20°.

Such a threshold enables an acceptable accuracy to be achieved.

According to one possibility compatible with the preceding possibilities, said symbology may comprise a symbol that has a color that varies as a function of a level of danger of the obstacle, determined as a function of an estimated distance or impact time between the obstacle and the aircraft.

Color coding indicating the level of danger, as a function of the distance or time to impact evaluated using the current velocity vector and the distance, may facilitate visual interpretation and decision-making by the pilot.

According to one possibility compatible with the preceding possibilities, if for a representative point said angle is less than or equal to the predetermined angular threshold, then this representative point is a point of interest that may belong to the ground, said processing comprising detecting each ground point belonging to the ground among the points of interest.

A first filter then consists in determining the point or points of interest likely to belong to the ground, as a function of the inclination of the associated normal.

The normal may be determined by a conventional method based on a decomposition into eigenvalues. For each representative point, the neighboring points and then the centroid of the group of points comprising this representative point and the neighboring points are determined. A covariance matrix is determined using the centroid and neighboring points. This matrix captures both the variation and the orientation of these neighboring points relative to their centroid, providing information about the local spatial distribution. The eigenvectors of the covariance matrix are then calculated and represent the main directions of the variation of the neighboring points. The eigenvector associated with the smallest eigenvalue is then the normal sought.

According to one possibility compatible with the preceding possibilities, said neighboring points of a representative point for which the normal is estimated may comprise all the representative points located at a distance less than a predetermined distance from this representative point.

According to one possibility compatible with the preceding possibilities, said detection of each ground point belonging to the ground among the points of interest may comprise a comparison between an altitude of each point of interest and an average altitude of the points representative of the vicinity, a point of interest being a ground point when the altitude of the point of interest minus the altitude of each point representative of the vicinity is less than a predetermined limit and each point representative of the vicinity of the point of interest is also a point of interest, the altitude of a point of interest being equal to the coordinate of this point of interest along the first axis.

Each point of interest is definitively considered as belonging to the ground if this point of interest meets a criterion of proximity in altitude reached if this point of interest is substantially at the same altitude as its neighbors, within a tolerance, and a criterion of vicinity coherence reached if the points of the vicinity are also points of interest. This method can optimize computation time. In addition, this method makes it possible to obtain an accurate and robust identification of the points belonging to the ground in a point cloud.

For example, said predetermined limit may be equal to 1.5 meters.

For example, the vicinity of a point of interest may comprise a predetermined number of closest representative points in a sphere centered on that point of interest.

For example, the predetermined number is equal to 15. Thus, by way of illustration, the vicinity of a point of interest studied comprises the 15 representative points closest to this point of interest, studied in a sphere centered on this point of interest studied.

According to another method, said detecting of each ground point may comprise the application of a random consensus algorithm by sampling, that determines at least one parameter of a planar model and each point of interest consistent with this planar model, each point of interest consistent with this planar model being a ground point.

The random consensus algorithm by sampling is also known by the expression "RANdom SAmple Consensus", and the acronym RANSAC. This algorithm is an iterative method used to estimate the parameters of a predetermined model that best represent the initial point cloud from which a set of outlier points is subtracted. Here, the model is an affine plane and the parameters characterize its orientation and a point that belongs to it. In the usual way, the algorithm iteratively selects subsets of points having a predetermined size from among the already filtered points of interest. This selection is performed randomly to estimate planar models and, after having performed a limited number of iterations, the algorithm selects the so-called optimal planar model that is closest to the random subset from which it is derived. Then the points that are at a distance from this plane greater than an optimal threshold are retained as points of interest that do not belong to the ground.

The disclosure further relates to an aircraft having at least one rotary wing, said aircraft having an obstacle detection system comprising at least one LIDAR obstacle sensing device as well as a controller and a display, the controller communicating with said at least one LIDAR obstacle sensing device and said display.

The obstacle detection system is configured to implement the above-described method. Thus: said at least one LIDAR obstacle sensing device is configured to perform said acquisition of a detected point cloud; said controller is configured to perform said positioning of each detected point in a predetermined orthonormal reference frame attached to the aircraft, said dividing of the surrounding space into volumetric units, said segmenting of the ground, and said determining of the presence or absence of at least one obstacle; and said display is configured to perform, in the presence of at least one obstacle, said displaying of a symbology illustrating said obstacle with respect to the aircraft.

### BRIEF DESCRIPTION OF THE DRAWINGS

The disclosure and its advantages appear in greater detail from the following description of examples given by way of illustration with reference to the accompanying figures, wherein:

FIG. 1 is a top view of an aircraft according to the disclosure;

FIG. 2 is a diagram illustrating an obstacle detection system according to the disclosure;

FIG. 3 is a flow chart illustrating the method implemented by such an obstacle detection system;

FIG. 4 is a diagram showing a display of such an obstacle detection system showing obstacles in two dimensions; and

FIG. 5 is a diagram showing a display of such an obstacle detection system showing obstacles in three dimensions.

### DETAILED DESCRIPTION

Elements present in more than one of the figures are given the same references in each of them.

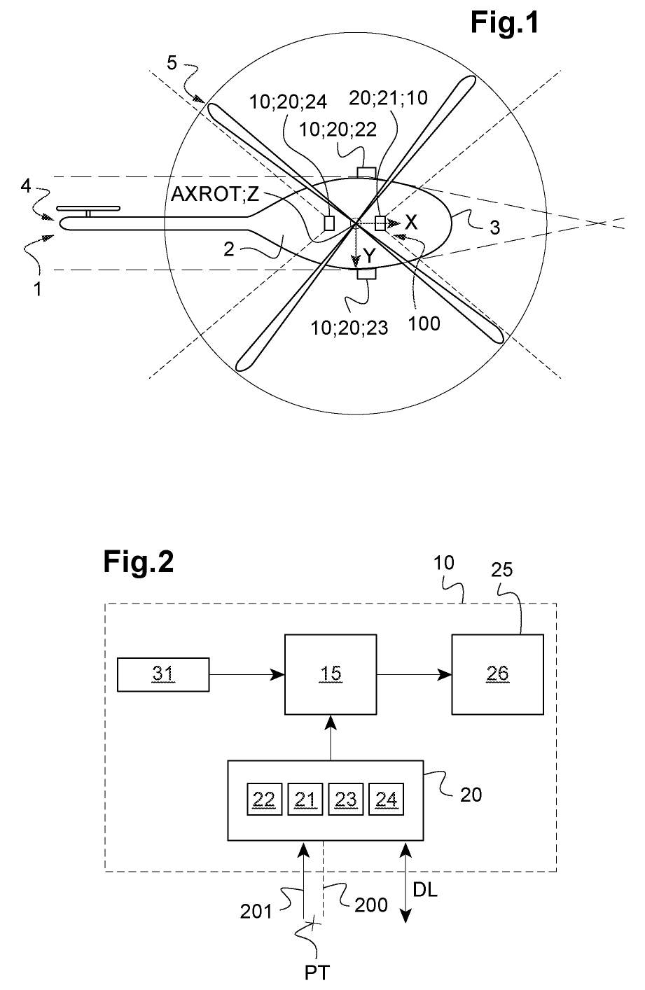

FIG. 1 shows an aircraft 1 according to the disclosure provided with a rotary wing 5 able to rotate about an axis of rotation AXROT.

For example, the aircraft 1 comprises an airframe 2 that extends longitudinally along its roll axis and from the rear towards the front, from a tail 4 towards a nose 3, transversely from a first flank to a second flank and in elevation from a hull to an apex. The rotary wing 5 is thus able to rotate above the airframe 2 according to FIG. 1.

Furthermore, the aircraft 1 comprises an obstacle detection system 10 for detecting possible obstacles present in a surrounding space, and if necessary for signaling them to a pilot. The detected obstacle or obstacles are positioned in a predetermined orthonormal reference frame 100 attached to the aircraft 1. This reference frame 100 has a first axis Z coincident with an axis of rotation AXROT of the rotary wing 5, and a second axis X and a third axis Y perpendicular to the first axis Z. The second axis X extends longitudinally in a direction running from the rear to the front, or vice versa, while the third axis Y extends transversely in a direction running from one flank to the other flank.

This obstacle detection system 10 comprises an obstacle sensor 20 for detecting obstacles, for example over 360 degrees about the axis of rotation AXROT.

The obstacle sensor 20 may be configured to scan obstacles in a first volume covering 360 degrees in azimuth about the axis of rotation AXROT of the rotary wing 5 and having an opening in elevation ranging from +10° above the rotary wing 5 to -20° below the rotary wing 5. Moreover, the obstacle sensor 20 may be configured to be able to cover, towards the front of the aircraft 1, a second volume encompassing part of the first volume, extending in azimuth relative to said frame of reference over 120 degrees for example, and having an opening in elevation ranging from +10° above the rotary wing 5 to -50° below the rotary wing 5.

The obstacle sensor 20 can be configured to detect obstacles at a speed of up to 30 knots (approximately 55.56 kilometers per hour), and with a maximum range of order 200 meters. Thus, such an obstacle sensor 20 then offers a pilot an acceptable reaction time.

For this purpose, the obstacle sensor 20 comprises at least one LIDAR obstacle sensing device 21, 22, 23, 24. According to the example in FIG. 1, the obstacle sensor 20 comprises at least four LIDAR obstacle sensing devices 21, 22, 23, 24, located for example in the vicinity of the rotary wing 5. For example, a first LIDAR obstacle sensing device 21 is carried by the airframe under the rotary wing and directed towards the front of the aircraft 1, for example to cover the aforementioned second volume, and may be inclined downwards and forwards in relation to the aircraft 1, and two LIDAR obstacle sensing devices 22, 23 are carried by the airframe under the rotary wing and directed to cover volumes on the respective sides of the two flanks, and a fourth LIDAR obstacle sensing device 24 is carried by the airframe under the rotary wing and directed towards the rear of the aircraft 1. Optionally, the LIDAR obstacle sensing devices 21, 22, 23, 24 may cover overlapping volumes. Reference should be made to the literature for examples of a sensor provided with at least one LIDAR sensing device.

Each LIDAR obstacle sensing device 21 can emit pulses of light, and for this purpose comprises, by way of example, a plurality of LASER diodes.

With reference to FIG. 2, the obstacle detection system 10 further comprises a controller 15 comprising at least one processing unit. Such a processing unit may comprise, for example, at least one processor and at least one memory, at least one integrated circuit, at least one programmable system, or at least one logic circuit, these examples not limiting the scope to be given to the term "processing unit". The term "processor" may be used equally well to mean a central processing unit (CPU), a graphics processing unit (GPU), a digital signal processor (DSP), a microcontroller, etc.

The controller 15 is in communication with the obstacle sensor 20, i.e., with the obstacle sensing device or devices 21, 22, 23, 24.

Furthermore, the controller 15 may be in wired or wireless connection with a speed sensor 31. The speed sensor 31 may comprise at least one sensing device for determining a velocity vector of the aircraft 1. For example, the speed sensor 31 may comprise a receiver of a satellite positioning device, a navigation system using the Doppler-Fizeau effect, an inertial unit, etc.

Furthermore, the controller 15 is in wired or wireless connection with a display 25. This display 25 may comprise a display means 26, such as a screen, a helmet visor, a glasses lens, a head-up collimator or the like.

The controller 15 may comprise, for example, a processing computer for implementing the disclosure and a symbol generator computer for displaying symbols on the display within one or more processing units. The symbol generator computer 22 may be integrated into the display 25 or remote. According to one example, the display 25 and the symbol generator computer may form one and the same piece of equipment, the processing computer being a computer that may or may not be dedicated to the method of the disclosure.

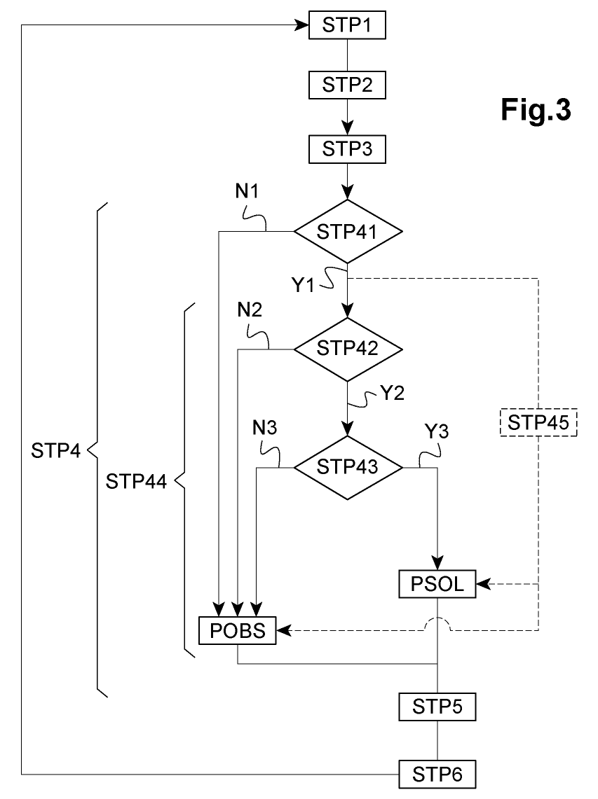

Irrespective of the embodiment of the obstacle detection system 10, FIG. 3 illustrates the obstacle detection method according to the disclosure implemented by such an aircraft 1 in an iterative manner.

This method comprises acquiring a detected point cloud, during a step STP1 and using the obstacle sensing device 20. Each LIDAR obstacle sensing device 21, 22, 23, 24 emits a light beam 200. When a light beam 200 impinges on a point of an obstacle referred to for convenience as a "detected point PT", an echo 201 is reflected to the obstacle sensing device 21, 22, 23, 24. The obstacle sensing device 21, 22, 23, 24 deduces therefrom positioning data enabling the obstacle to be located in the reference frame 100, or even the light intensity of the echo 201. This positioning data may comprise the distance DL separating the detected point PT from the obstacle sensing device 21 as well as an angle of azimuth and an angle of elevation in the reference frame of the obstacle sensing device.

Then, the method comprises positioning, during a step STP2 and using the controller 15, of each detected point PT in the reference frame 100. The controller 15 is then configured, for example by executing instructions stored in a memory, to implement this step.

These two initial steps STP1, STP2 enable the detected points PT, detected in the surrounding space, to be structured in a coherent manner.

The method then comprises dividing, during a step STP3 and using the controller 15, of the surrounding space into volumetric units having a predetermined geometry. All the detected points PT present in the same volumetric unit are in addition replaced by a representative point.

The controller 15 then applies a typical "voxelization" algorithm for this purpose. The controller 15 is then configured, for example by executing instructions stored in a memory, to implement this step.

According to one possibility, the controller 15 calculates the coordinates of the representative point of each volumetric unit, by considering that this representative point is the equally-weighted barycenter of the detected points of this volumetric unit. The coordinates of the representative point are calculated as a function of the coordinates of the detected points of the volumetric unit.

Alternatively, the controller 15 calculates the coordinates of the representative point of each volumetric unit in the reference frame 100 by considering that this representative point is the barycenter of the detected points of this volumetric unit weighted by a light intensity of these detected points. The coordinates of the representative point are therefore calculated as a function of the coordinates of the detected points of the volumetric unit weighted by the light intensity of the detected points.

This method, using various geometric shapes such as cubes or parallelepipeds for example, simplifies the management of a very large number of detected points, by balancing computational complexity and precision.

The method then comprises segmenting the ground implemented using the controller 15. The controller 15 is then configured, for example by executing stored instructions, to implement this step. The controller 15 identifies, among the representative points, the ground points belonging to the ground overflown, in order to reduce the calculation time.

This segmenting of the ground comprises a processing, during a step STP4 implemented using the controller 15, enabling the representative points POBS not belonging to the ground and the representative points called "ground points" belonging to the ground to be identified.

During this processing, the controller 15 is configured to determine points of interest among the representative points during a step STP41. This processing also comprises detecting, during a step STP44, each ground point belonging to the ground among the points of interest.

For this purpose, the processing comprises, for each representative point, detecting, during a step STP41 implemented using the controller, whether a normal passing through this representative point forms or does not form an angle with an axis parallel to the axis of rotation greater than a predetermined angular threshold. This normal is a normal to a surface, this surface passing through this representative point and neighboring points. For example, said predetermined angular threshold is equal to 20°. If the normal forms an angle with an axis parallel to the axis of rotation greater than the predetermined angular threshold, then the representative point does not belong to the ground.

Such filtering by calculation of normals reduces the complexity of the processing and quickly excludes the points that do not meet the planar criteria associated with the ground.

For this purpose, for each volumetric unit, the controller 15 is configured to determine the normal, at a representative point, to a surface passing through this representative point and the neighboring points. For each representative point, the neighboring points comprise all the representative points located at a distance less than a predetermined distance, for example of order 2 to 4 times the length of one side of a volumetric unit, from this representative point. The controller 15 then determines an angle separating this normal from an axis parallel to the axis of rotation and compares it to the predetermined angular threshold. If this angle is not less than or equal to the predetermined angular threshold, in accordance with arrow N1, the representative point is not a point belonging to the ground but a point referred to as an "obstacle point POBS" that may belong to an obstacle. Conversely and according to arrow Y1, the representative point is a point of interest that may be a ground point PSOL.

Therefore, FIG. 3 describes two variants for carrying out step STP44 aimed at evaluating whether a point of interest is an obstacle point POBS or a ground point PSOL.

According to the first variant illustrated by continuous lines, detecting STP44 of each ground point PSOL belonging to the ground among the points of interest comprises a comparison, during a step STP42, between an altitude of each point of interest and an average of the altitudes of the representative points of the vicinity. The controller 15 thus determines a difference between the altitude of each point of interest and the average of the altitudes of the points in the vicinity. If this difference is less than a predetermined limit, for example equal to 1.5 meters, then in accordance with arrow N2, the point of interest is not a ground point PSOL but an obstacle point POBS. Conversely and according to arrow Y2, the point of interest may be a ground point PSOL.

It should be noted that the vicinity of a point of interest comprises a predetermined number, for example equal to 15, of closest representative points in a sphere centered on this point of interest.

After, at the same time as or before the step STP42, the controller 15 determines, during a step STP43, whether each point representative of the vicinity of the point of interest is also a point of interest meeting the criterion of the aforementioned normal. If not and in accordance with arrow N3, the point of interest is not a ground point PSOL but an obstacle point POBS. Conversely and according to arrow Y3, the point of interest may be a ground point PSOL.

Therefore, the controller 15 estimates that a representative point is a ground point if three conditions are met at the same time, namely: i) if the representative point is a point of interest, ii) the altitude of a representative point is substantially equal to the average of the altitudes of the representative points of the vicinity, and iii) the representative points of the vicinity are points of interest.

According to the second variant illustrated by dashed lines, detecting STP44 of each ground point PSOL comprises the application, during a step STP45, of a random consensus algorithm by sampling, that determines at least one parameter of a planar model and each point of interest consistent with this planar model, each point of interest consistent with this planar model being a ground point PSOL.

Irrespective of the variant, the method comprises determining, during a step STP5 implemented using the controller 15, the presence or absence of at least one obstacle based on the representative points distinct from the ground, i.e., the obstacle points POBS. The controller 15 is then configured, for example by executing stored instructions, to implement this step.

Thus, after the ground segmentation, the detected points PT that do not meet the ground criteria are clustered by the controller 15. This step makes it possible to clearly identify and distinguish potential obstacles in the environment by applying a method known to a person skilled in the art.

Therefore, in the presence of at least one obstacle, the method comprises displaying STP6, on a display 25, a symbology illustrating said obstacle with respect to the aircraft 1.

For example, the controller 15 transmits a digital signal to the display 25 bearing the information to be displayed. The results can be displayed in two or three dimensions. In addition, a symbol representing an obstacle may have a color that varies as a function of a level of danger of the obstacle, determined as a function of a distance or time to impact between the obstacle and the aircraft 1.

For example, an obstacle is not considered dangerous if it is located at a distance or at an estimated time to impact greater than a first predetermined respective value, moderately dangerous if it is located at a distance or at a time to impact less than or equal to the first predetermined respective value and greater than a second predetermined respective value, and dangerous if it is located at a distance or at a time to impact less than or equal to the second predetermined respective value.

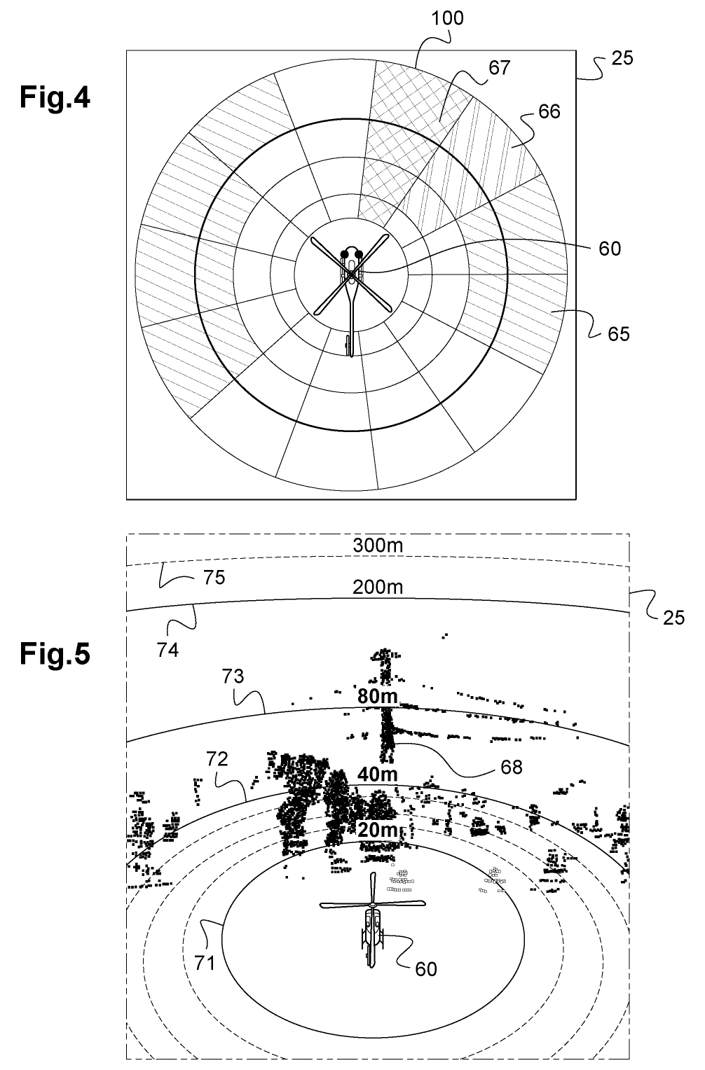

FIG. 4 illustrates an embodiment displaying the results in two dimensions through a polar graph.

The screen shows an aircraft symbol 60 representing the aircraft 1. This aircraft symbol 60 is at the center of concentric circles cut into angular sectors 65-67. Each angular sector shows a symbol that may illustrate the presence of an obstacle. If an obstacle is detected in an angular sector, this angular sector 65-67 is highlighted, possibly as a function of the estimated dangerousness of the obstacle. For example, an angular sector 65 is colored green if the obstacle is not considered dangerous, an angular sector 66 is colored orange if the obstacle is moderately dangerous, and an angular sector 67 is colored red if the obstacle is considered dangerous.

FIG. 5 illustrates an embodiment displaying the results in three dimensions. Only the obstacles are displayed by means of symbols 68, while the ground is either removed or colored differently to provide better distinction. The symbols can take the form of dots, with each symbol representing an obstacle point. Circular arcs 71-75 may be disposed at ground level to illustrate distances from the aircraft.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A method for detecting obstacles, implemented by an aircraft having at least one rotary wing,
wherein the obstacle detection method comprises:
acquiring a detected point cloud using at least one LIDAR obstacle sensing device installed on-board the aircraft;
positioning each detected point in a predetermined orthonormal reference frame attached to the aircraft, this reference frame having a first axis coincident with an axis of rotation of the rotary wing;
dividing the surrounding space into volumetric units having a predetermined geometry, the detected point or points present in the same volumetric unit being all replaced by a representative point;
segmenting the ground by processing in order to detect each ground point belonging to the ground among the representative points; the processing comprising, for each representative point, detecting whether a normal passing through this representative point does or does not form an angle with an axis parallel to the axis of rotation, greater than a predetermined angular threshold, the normal being a normal to a surface comprising this representative point and neighboring points; and
determining the presence or absence of at least one obstacle by clustering the representative points distinct from the ground points and, in the presence of at least one obstacle, displaying, on a display, a symbology illustrating the obstacle with respect to the aircraft.

2. The method for detecting obstacles according to claim 1,
wherein the point representative of a volumetric unit is the equally-weighted barycenter of the detected points of this volumetric unit, or the barycenter of the detected points of this volumetric unit weighted by a light intensity of these detected points, the light intensity being provided by the LIDAR obstacle sensing device.

3. The method according to claim 1,
wherein the predetermined angular threshold is equal to 20°.

4. The method according to claim 1,
wherein the symbology has a symbol that has a color that varies as a function of a level of danger of the obstacle, determined as a function of an estimated distance or impact time between the obstacle and the aircraft.

5. The method according to claim 1,
wherein the neighboring points of a representative point for which the normal is estimated comprise all the representative points located at a distance less than a predetermined distance from this representative point.

6. The method according to claim 1,
wherein if for a representative point the angle is less than or equal to the predetermined angular threshold, then this representative point is a point of interest that may belong to the ground, the processing comprising detecting each ground point belonging to the ground among the points of interest.

7. The method for detecting obstacles according to claim 6,
wherein detecting each ground point belonging to the ground among the points of interest comprises comparing between an altitude of each point of interest and an average altitude of the points representative of a vicinity, a point of interest being a ground point when the altitude of the point of interest minus the altitude of each point representative of the vicinity is less than a predetermined limit and each point representative of the vicinity of the point of interest is also a point of interest, the altitude of a point of interest being equal to the coordinate of this point of interest along the first axis.

8. The method for detecting obstacles according to claim 7,
wherein the predetermined limit is equal to 1.5 meters.

9. The method according to claim 7,
wherein the vicinity of a point of interest comprises a predetermined number of closest representative points, within a sphere centered on that point of interest.

10. The method for detecting obstacles according to claim 6,
wherein detecting each ground point belonging to the ground among the points of interest comprises applicating a random consensus algorithm by sampling, that determines at least one parameter of a planar model and each point of interest consistent with this planar model, each point of interest consistent with this planar model being a ground point.

11. An aircraft having at least one rotary wing, the aircraft having an obstacle detection system comprising at least one LIDAR obstacle sensing device, as well as a controller and a display, the controller communicating with the at least one LIDAR obstacle sensing device and the display,
wherein the obstacle detection system is configured to implement the method according to claim 1:
the at least one LIDAR obstacle sensing device being configured to acquiring a detected point cloud;
the controller being configured to positioning each detected point in a predetermined orthonormal reference frame attached to the aircraft, dividing the surrounding space into volumetric units, segmenting the ground, and determining the presence or absence of at least one obstacle; and
the display being configured to, in the presence of at least one obstacle, displaying a symbology illustrating the obstacle with respect to the aircraft.
